(19) United States
(12) Patent Application Publication
(10) Pub. No.: US 2005/0200099 A1
(43) Pub. Date: Sep. 15, 2005

(54) Hitch fast trailer tongue locator

(76) Inventors: Lonnie Moberly, Winchester, KY (US); Donald R. Smith, Winchester, KY (US)

Correspondence Address: DONALD R. SMITH, 18 CASSALANDA WAY, WINCHESTER, KY, 40391, US

(21) Appl. No.: 10/796,636

(22) Filed: Mar. 9, 2004

(51) Int. Cl. B60D 1/36

(52) U.S. Cl. 280/477

(57) ABSTRACT

This invention takes the hitch to trailer alignment to the next level by allowing an individual to hook up a trailer quickly without help or getting in and out of a vehicle to align a trailer tongue to the vehicle hitch ball. These designs are easily manufactured. There are no similar products in the marketplace today.

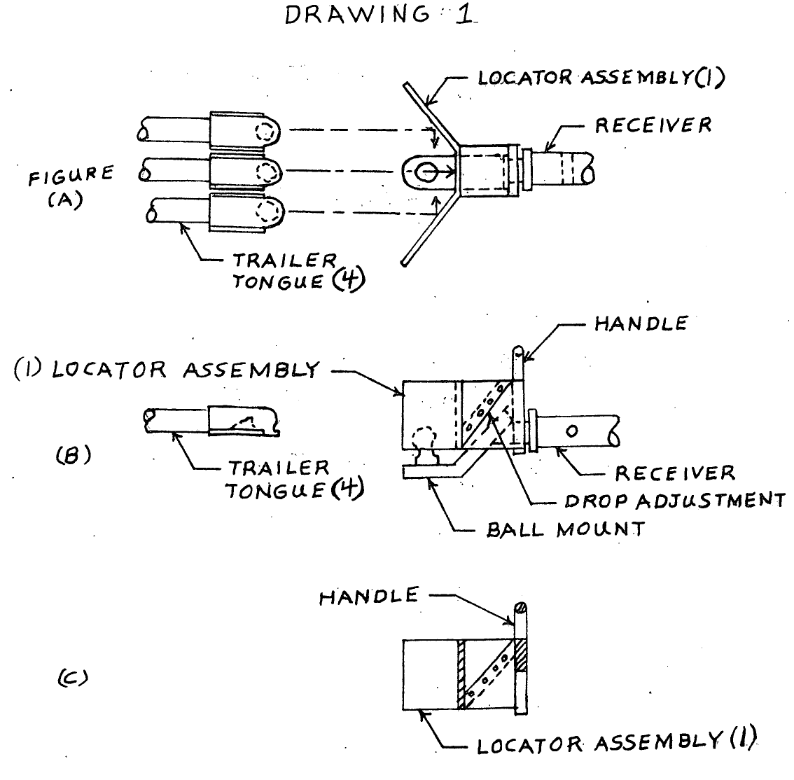

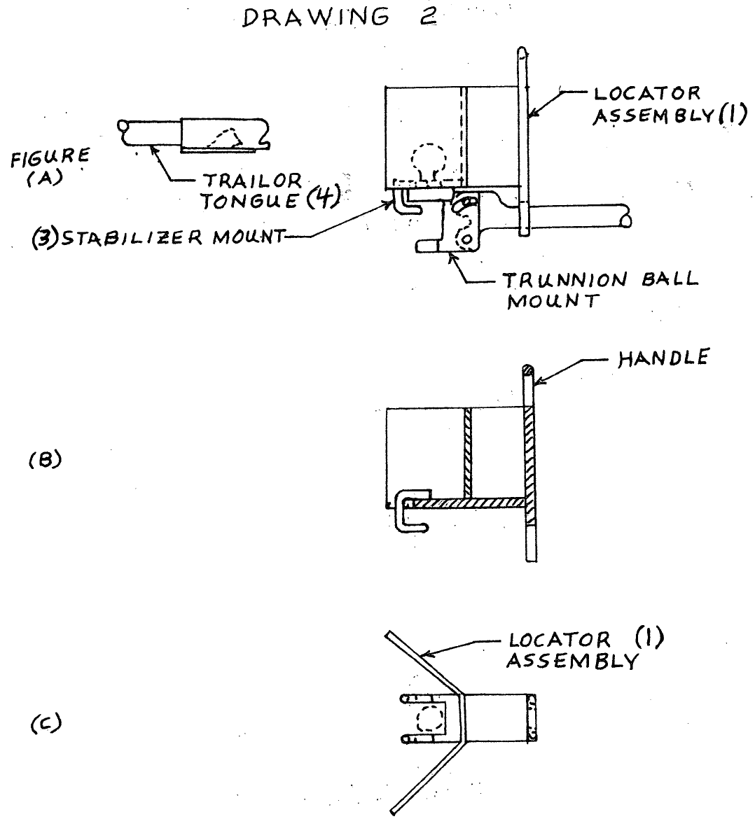

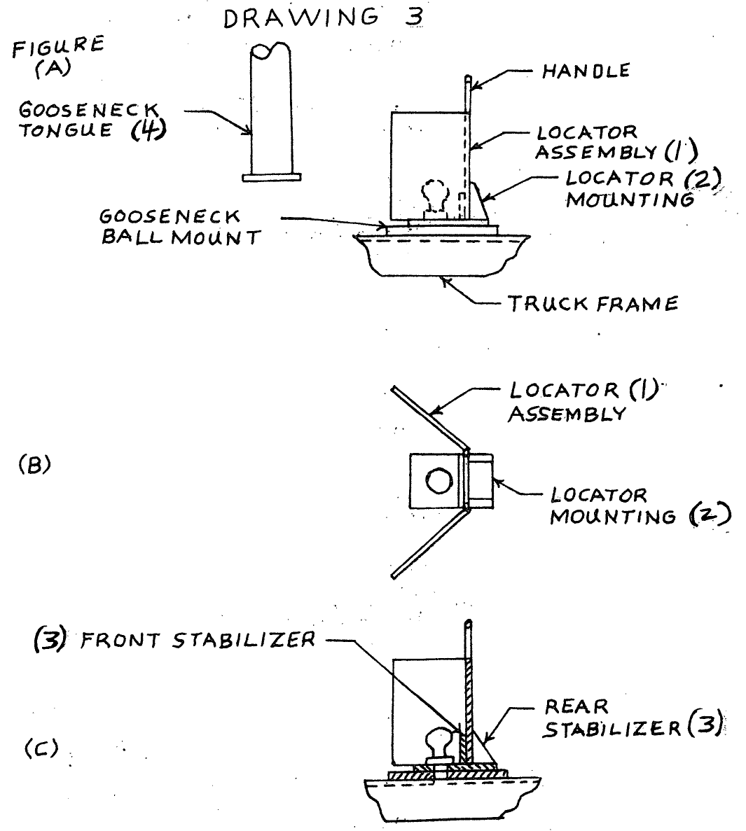

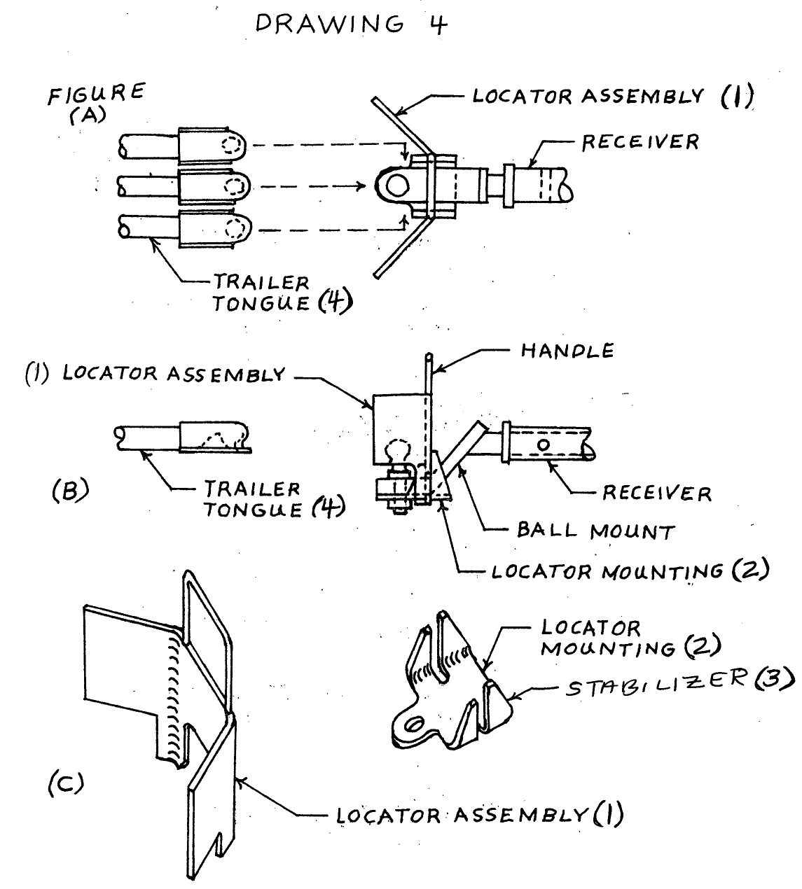

### SUMMARY OF INVENTION

One person to hook up trailer. This invention allows trailer tongues to be aligned with hitch ball quickly by not having to get in and out of the vehicle or having help to align trailer tongue to ball mount.

### DESCRIPTION OF DRAWINGS

Drawing number one:

Figure (A): Top view shows different positions of trailer tongue and locator assembly mounted on a ball mount

Figure (B): Side view of trailer tongue and locator assembly with drop adjustment mounted on ball mount

Figure (C): Center sectioned of locator assembly with handle for easy removal from ball mount

Drawing number two:

Figure (A): Side view of trailer tongue location and how locator assembly mounts to trunnion ball mount

Figure (B): Side view of locator assembly sectioned and handle for removal of locator assembly

Figure (C): Top view of locator assembly relative to trailer ball

Drawing number three:

Figure (A): Side view shows gooseneck tongue location and removal locator assembly in locator mounting

Figure (B): Top view shows locator assembly mounted in locator mounting

Figure (C): Side view of locator assembly sectioned with locator mounting stabilizers

Drawing number four:

Figure (A): Top view shows different positions of trailer tongue and locator assembly mounted to ball mount with ball

Figure (B): Side view of trailer tongue and locator assembly mounted to ball mount

Figure (C): This view shows locator assembly with handle and locator mounting bracket

### DESCRIPTION OF INVENTION

This invention can be designed to adapt to any type of ball mount or one piece hitch. The locator assembly can be removed with handle after trailer is hooked. The drawings depict designs to mount locator assembly to different types of ball mounts. The locator assembly must be removed prior to vehicle moving because it would limit turning angle.

1. Locates trailer tongue to ball quickly for hookup

2. Locator assembly can be designed to fit all types of ball mounts or one piece hitches

3. Locator assembly easily removed after hook up with handle

4. Locator assembly prevents need for help in hooking up trailers or getting in and out of vehicle to locate trailer tongue to ball
